(19) United States
(12) Patent Application Publication
(10) Pub. No.: US 2017/0355254 A1
(43) Pub. Date: Dec. 14, 2017

(54) SEALING STRUCTURE OF A DOOR FRAME

(71) Applicant: Hyundai Motor Company, Seoul (KR)

(72) Inventors: Sang Hyun LEE, Jeju-si (KR); Jae Hyuk Cheong, Hwaseong-si (KR); Hyeokji Lee, Jinju-si (KR)

(73) Assignee: Hyundai Motor Company, Seoul (KR)

(21) Appl. No.: 15/280,719

(22) Filed: Sep. 29, 2016

(30) Foreign Application Priority Data
Jun. 8, 2016 (KR) 10-2016-0071070

(51) Int. Cl. B60J 10/84; B60J 10/74; E06B 7/16; B62D 29/04

(52) U.S. Cl. CPC B60J 10/84; B62D 29/043; B60J 10/74; E06B 7/16

(57) ABSTRACT

A sealing structure of a door frame of a vehicle to seal a body weather strip disposed at a body and a side outer panel of the vehicle to prevent noise, the door frame including a fitting end bent to an outside at an upper end, an installing end protruding to an inside at lower side of the fitting end, and a curved portion contacting the body weather strip, may include an outside weather strip unit including an upper weather strip correspondingly contacting a side outer panel and a lower weather strip introducing a door glass integrally or monolithically formed at an upper surface and lower surface of a carrier disposed at a fitting end of the door frame, an inside weather strip disposed at an installing end of the door frame to correspondingly contact the side outer panel, and a molding device inserted and fixed in one side of the carrier.

### CROSS-REFERENCE TO RELATED APPLICATION

The present application claims priority to Korean Patent Application No. 10-2016-0071070, filed Jun. 8, 2016, the entire contents of which is incorporated herein for all purposes by this reference.

### BACKGROUND OF THE INVENTION

### Field of the Invention

The present invention relates to a sealing structure of a door frame. More particularly, to a sealing structure of a door frame improving assemblability.

### Description of Related Art

Generally, a sealing structure of a door frame (hereinafter, simply referred to as a sealing structure) is applied at a door of the vehicle for preventing moisture, dust, and noise inflow into inside of the vehicle. The sealing structure is disposed at the door frame of the door to operate between a body weatherstrip and a side outer panel of the vehicle body. This sealing structure includes a door frame molding having gloss to realize greater luxury appearance regardless door types. If the sealing structure has an excellent combination, it is confirmed that not an open and close operation but shaking or shape of sealing is excellent. However, a conventional sealing structure has a problem that coherence force is deteriorated because the door frame molding is assembled by simple fitting type at an outer side of a glass run introducing a window glass. Also, in the conventional sealing structure, the weatherstrip contacted with the side outer panel is fixed at the door frame by a clip, duration and coherence force is low.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a sealing structure in which a molding device is fitted into an insert home formed at one side of an outside weather strip unit through an insert end as a wedge shape to improve coherence force, and the outside weather strip unit is strongly fitted to improve coherence force in a state in which the outside weather strip unit is fitted to the fitting end of the door frame.

According to various aspects of the present invention, a sealing structure of a door frame disposed at the door frame of a vehicle to seal a body weather strip disposed at a body and a side outer panel of the vehicle to prevent noise, the door frame including a fitting end bent to an outside at an upper end, an installing end protruding to an inside at lower side of the fitting end, and a curved portion contacting the body weather strip to a lower inside, may include an outside weather strip unit including an upper weather strip correspondingly contacting a side outer panel and a lower weather strip introducing a door glass integrally or monolithically formed at an upper surface and lower surface of a carrier disposed at a fitting end of the door frame, an inside weather strip disposed at an installing end of the door frame to correspondingly contact the side outer panel, and a molding device inserted and fixed in one side of the carrier.

The outside weather strip unit may include the carrier in which a fitting home open to an inside direction at an upper side is formed to be fitted to the fitting end and assembled, and an insert home open to an outside direction at a lower side is formed so that the molding device is assembled, the upper weather strip integrally or monolithically formed by extrusion molding at the upper surface of the carrier and having a plurality of rims correspondingly contacting the side outer panel, and the lower weather strip integrally or monolithically formed by extrusion molding at the lower surface of the carrier and having a plurality of rims at both sides so that the door glass is inserted and introduced.

The lower weather strip may include a support surface at an inside lower portion to be supported by a supporting end formed at a lower end portion of the curved portion of the door frame through the support surface.

A space portion may be formed between the curved portion of the door frame and the lower weather strip.

The carrier may be fitted to the fitting end by a locking bump formed at a front end in a state of being fitted to the fitting end of the door frame through the fitting home.

The carrier may be made of plastic material.

The door frame may be made of Carbon Fiber Reinforced Plastic (CFRP) material.

The inside weather strip may include an installing home to be fitted to the installing end of the door frame and a cushion portion formed as a closed cross section surface at an upper side.

The molding device may include a molding in which an insert end is integrally or monolithically formed along an inside surface to be inserted to an insert home formed at the carrier, and a foil integrally or monolithically formed by extrusion molding surrounding an outside surface of the molding.

The molding may be fitted between the upper weather strip and the lower weather strip in state in which the upper end portion and the lower end portion are surrounded by the foil.

The insert end of the molding may be partially cut along a length direction to be fitted into the insert home of the carrier.

The insert end of the molding may be inserted into the insert home of the carrier to be fitted by a wedge shape.

According to various embodiments of the present invention, the carrier of the outside weather strip unit is made of light weight plastic material, and the upper weather strip and the lower weather strip are integrally or monolithically formed by an extrusion molding to improve formability.

Furthermore, according to various embodiments of the present invention, the inside weather strip is installed in the same direction as a direction of force applied when the door is closed to the door frame to improve fixing force of the inside weather strip.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of a sealing structure of a door frame according to various embodiments of the present invention.

FIG. 2 is a use cross-sectional view of a sealing structure of a door frame according to various embodiments of the present invention.

FIG. 3 is a partially cut-away perspective view of a door frame according to various embodiments of the present invention.

FIG. 4 is an exploded perspective view of a door frame according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

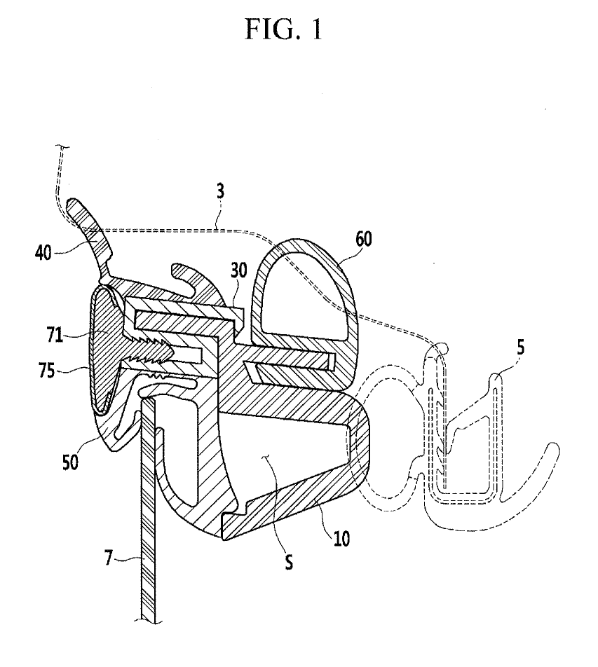

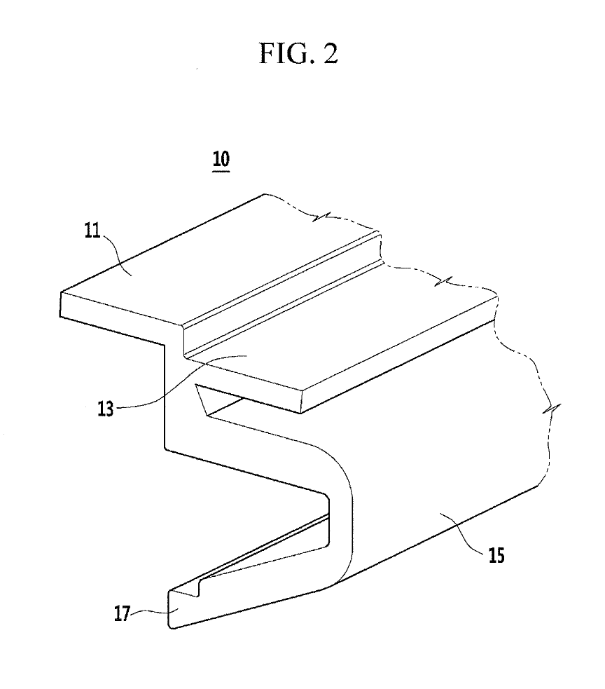

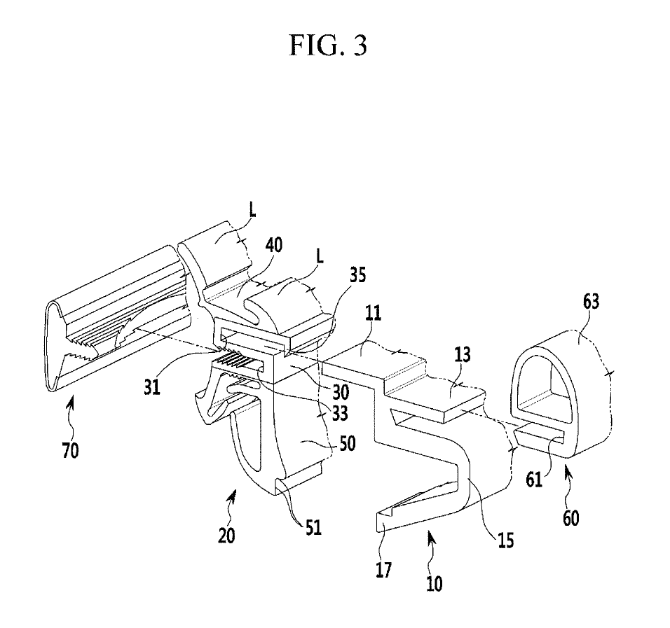

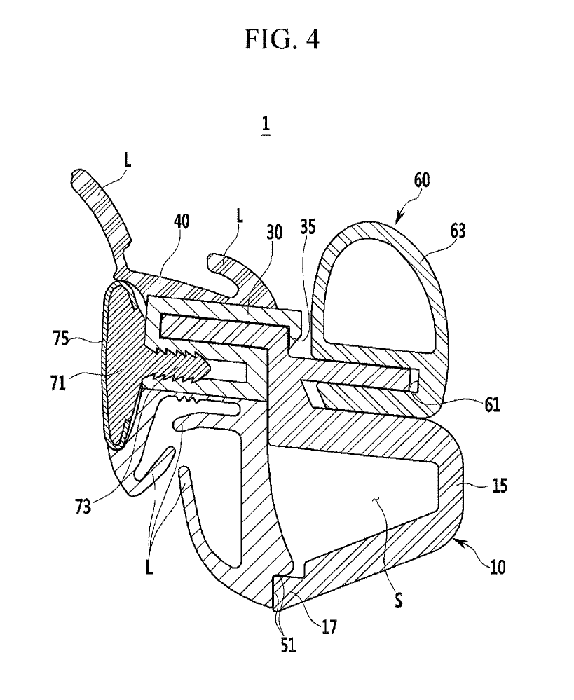

FIG. 1 is a cross-sectional view of a sealing structure of a door frame according to various embodiments of the present invention, FIG. 2 is a use cross-sectional view of a sealing structure of a door frame according to various embodiments of the present invention, FIG. 3 is a partially cut-away perspective view of a door frame according to various embodiments of the present invention, and FIG. 4 is an exploded perspective view of a door frame according to various embodiments of the present invention.

Referring to FIG. 1 and FIG. 2, a sealing structure of a door frame according to various embodiments of the present invention is disposed at a door frame of a door for a vehicle.

The sealing structure 1 of the door frame 10 seals a body weather strip 5 disposed at a vehicle body and a side outer panel 3 and prevents noise.

At this time, the door frame 10 according to various embodiments of the present invention, referring to FIG. 3, has a fitting end 11 bent towards outside at an upper end. Further, the door frame 10 has an installing end 13 protruded to inside at lower side of the fitting end 11 and a curved portion 15 contacting the body weather strip 5 at a lower inside. The door frame 10 may be made of Carbon Fiber Reinforced Plastic (CFRP) material.

Referring to FIG. 4, the sealing structure of the door frame according to various embodiments of the present invention includes an outside weather strip unit 20, an inside weather strip 60 and a molding device 70.

In some embodiments, the outside weather strip unit 20 includes a carrier 30, an upper weather strip 40 and a lower weather strip 50.

The carrier 30 has a fitting home 31 open to inside direction at an upper side to be fitted to the fitting end 11 and assembled. Further, the carrier 30 has an insert home 33 open towards an outside direction at a lower side to be assembled with the molding device 70 described below. This carrier 30 is fixed by a locking bump 35 formed at a front end in a state of being fitted to the fitting end 11 of the door frame 10 through the fitting home 31. The carrier 30 may be made of plastic material. In addition, the upper weather strip 40 may be integrally or monolithically formed by extrusion molding at an upper surface of the carrier 30.

In some embodiments, the upper weather strip 40 has a plurality of rims L correspondingly contacting the side outer panel 3. The upper weather strip 40 may be made of soft Thermal Plastic Elastomer (TPE) material.

Further, the lower weather strip 50 is integrally or monolithically formed by extrusion molding at a lower surface of the carrier 30.

In some embodiments, the lower weather strip 50 has a plurality of rims L at both sides so that the door glass 7 is inserted and introduced. Furthermore, the lower weather strip 50 has a support surface 51 at inside lower portion. The lower weather strip 50 may be made of middle degree hardness TPE material that is harder than the upper weather strip 40. The lower weather strip 50 is disposed to be supported by a supporting end 17 formed at a lower end portion of the curved portion 15 of the door frame 10 through the support surface 51. Here, a space portion S is formed between the curved portion 15 of the door frame 10 and the lower weather strip 50. That is, the outside weather strip unit 20 is integrally or monolithically formed with an upper weather strip 40 correspondingly contacting the side outer panel 3 at an upper surface of the carrier 30 installed at the fitting end 11 of the door frame 10. Likewise, the outside weather strip unit 20 is integrally or monolithically formed with the lower weather strip 50 introducing the door glass 7 at a lower surface of the carrier 30.

In some embodiments, the inside weather strip 60 is installed at an installing end 13 of the door frame 10 to correspondingly contact the side outer panel 3. The inside weather strip 60 has an installing home 61 to be fitted to the installing end 13 of the door frame 10. Further, the inside weather strip 60 has a cushion portion 63 formed as closed cross section surface at an upper side.

In some embodiments, the molding device 70 includes a molding 71 and a foil 75, and is inserted and fixed in at one side of the carrier 30. The molding 71 is integrally or monolithically formed along an inside surface to be inserted to the insert home 33 formed at the carrier 30. Accordingly, the insert end 73 of the molding 71 is partially cut along a in the length direction to be fitted into the insert home 33 of the carrier 30. Here, the insert end 73 is inserted into the insert home 33 of the carrier 30 to be fitted by a wedge shape.

In some embodiments, the molding 71 may be made of Polypropylene (PP) material. Further, the foil 75 is integrally or monolithically formed by extrusion molding surrounding outside surface of the molding 71. At this time, the foil 75 may be made of stainless material, and of 500 μm thickness. The molding device 70 above described is fitted between the upper weather strip 40 and the lower weather strip 50 in a state in which the upper end portion and the lower end portion are surrounded by the foil 75.

Accordingly, in the sealing structure 1 of a door frame 10 according to various embodiments of the present invention, the carrier 30 of the outside weather strip unit 20 is made of light weight plastic material, and the upper weather strip 40 and the lower weather strip 50 are integrally or monolithically formed by an extrusion molding to improve formability.

In addition, according to sealing structure 1 of the door frame, the inside weather strip 60 is installed in the same direction as a direction of force applied when the door is closed to the door frame 10 to improve fixing force of the inside weather strip 60.

Furthermore, according to the sealing structure 1 of the door frame, the locking bump 35 is applied to the carrier 30 to improve fixing force between the door frame 10 and the carrier 30.

Additionally, according to the sealing structure 1 of the door frame, a wedge shape is applied to the insert end 73 of the molding device 70 to improve fixing force between the molding device 70 and the carrier 30.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed:

1. A sealing structure of a door frame disposed at the door frame of a vehicle to seal a body weather strip disposed at a body and a side outer panel of the vehicle to prevent noise, the door frame including a fitting end bent to an outside at an upper end, an installing end protruding to an inside at lower side of the fitting end, and a curved portion contacting the body weather strip to a lower inside,
the sealing structure of the door frame including:
an outside weather strip unit including an upper weather strip correspondingly contacting a side outer panel and a lower weather strip introducing a door glass integrally formed at an upper surface and lower surface of a carrier disposed at a fitting end of the door frame;
an inside weather strip disposed at an installing end of the door frame to correspondingly contact the side outer panel; and
a molding device inserted and fixed in a first side of the carrier.

2. The sealing structure of the door frame of claim 1, wherein the outside weather strip unit comprises:
the carrier in which a fitting home open to an inside direction at an upper side is formed to be fitted to the fitting end and assembled, and an insert home open to an outside direction at a lower side is formed so that the molding device is assembled;
the upper weather strip integrally formed by extrusion molding at the upper surface of the carrier and having a plurality of rims correspondingly contacting the side outer panel; and
the lower weather strip integrally formed by extrusion molding at the lower surface of the carrier and having a plurality of rims at both sides so that the door glass is inserted and introduced.

3. The sealing structure of the door frame of claim 1, wherein the lower weather strip includes a support surface at an inside lower portion to be supported by a supporting end formed at a lower end portion of the curved portion of the door frame through the support surface.

4. The sealing structure of a door frame of claim 3, wherein a space portion is formed between the curved portion of the door frame and the lower weather strip.

5. The sealing structure of the door frame of claim 2, wherein the carrier is fitted to the fitting end by a locking bump formed at a front end in a state of being fitted to the fitting end of the door frame through the fitting home.

6. The sealing structure of the door frame of claim 2, wherein the carrier is made of plastic material.

7. The sealing structure of the door frame of claim 1, wherein the door frame is made of Carbon Fiber Reinforced Plastic (CFRP) material.

8. The sealing structure of the door frame of claim 1, wherein the inside weather strip includes an installing home to be fitted to the installing end of the door frame and a cushion portion formed as a closed cross section surface at an upper side.

9. The sealing structure of the door frame of claim 1, wherein the molding device includes:
a molding in which an insert end is integrally formed along an inside surface to be inserted to an insert home formed at the carrier; and
a foil integrally formed by extrusion molding surrounding an outside surface of the molding.

10. The sealing structure of the door frame of claim 9, wherein the molding is fitted between the upper weather strip and the lower weather strip in state in which the upper end portion and the lower end portion are surrounded by the foil.

11. The sealing structure of the door frame of claim 9, wherein the insert end of the molding is partially cut along a length direction to be fitted into the insert home of the carrier.

12. The sealing structure of a door frame of claim 11, wherein the insert end of the molding is inserted into the insert home of the carrier to be fitted by a wedge shape.
